(19) United States
(12) Patent Application Publication
(10) Pub. No.: US 2006/0033856 A1
(43) Pub. Date: Feb. 16, 2006

(54) Display device with varistor layer

(76) Inventors: Hans-Helmut Bechtel, Roetgen (DE); Yourii Martynov, Eindhoven (NL); Wolfgang Busselt, Roetgen (DE); Wilhelm Groen, Einighausen (NL); Petra Huppertz, Roetgen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/533,715

(22) PCT Filed: Oct. 28, 2003
(86) PCT No.: PCT/IB03/04755

§ 371 Date: May 3, 2005

(30) Foreign Application Priority Data
Nov. 6, 2002 (DE) 102 51 583.2

(51) Int. Cl. G02F 1/136

(52) U.S. Cl. 349/53

(57) ABSTRACT

The invention relates to a display device comprising a first electrode (2) and a second electrode (6), and an optical layer (3) arranged between the electrodes (2, 6), which optical layer (3) emits light under the influence of an electric field applied between said electrodes (2, 6), and comprising a varistor layer (5) which is situated at least in the area of the pixels of the display device.

The invention relates to a display device comprising a first electrode and a second electrode, and an optical layer arranged between the electrodes, which optical layer emits light under the influence of an electric field applied between said electrodes.

To preclude loss of contrast caused by so-termed “crosstalk” during driving of picture elements (pixels) in passive-matrix display devices, such as liquid crystal display devices, each pixel is provided with an electronic switch. This electronic switch is, for example, a non-linear element such as an MIM diode (metal-insulator-metal-diode), a thin-film transistor or a varistor.

EP 0 337 711 B1 discloses, for example, a transmissive liquid crystal display device wherein each pixel electrode is connected via a varistor to the associated signal line.

A drawback of said display device resides in that in the case of large display screen diagonals with a large number of pixels also a large number of varistors must be applied. This is very time-consuming and expensive.

Therefore, it is an object of the invention to provide a display device that is operated by means of a multiplex drive enabling the electronic switches to be readily and inexpensively integrated in the matrix arrangement.

This object is achieved by a display device comprising a first electrode and a second electrode, and an optical layer arranged between the electrodes, which optical layer emits light under the influence of an electric field applied between said electrodes, and comprising a varistor layer arranged between an electrode and the optical layer.

Varistors are electric resistors having a very high resistance at low voltages but a low resistance at high voltages. Therefore, if a small voltage is applied between the first electrode and the second electrode the varistor layer serves as an insulator. In all, the electric field which then acts on the optical layer is small and no emission of (visible) light takes place. If, however, a high voltage exceeding a certain threshold is applied between the electrodes, then the varistor layer becomes conducting and serves quasi as an electrode. As a result the distance between the two electrodes suddenly changes, and a strong electric field acts on the optical layer. As a result of the suddenly occurring strong electric field, the optical layer emits (visible) light. The varistor layer brings about that the threshold at which light emission occurs is increased and that the slope of the luminance-voltage curve is steeper. Consequently, the difference in luminance between an addressed pixel and a non-addressed pixel is maximized and hence the contrast of a display device in accordance with the invention is improved.

The advantageous embodiment as claimed in claim 2 brings about that the contrast in the area of the pixels is improved.

The advantageous embodiment as claimed in claim 3 can be produced in a simple and inexpensive manner because the varistor layer does not have to be structured.

The dielectric layer advantageously present between the varistor layer and the optical layer, as claimed in claim 4, precludes breakdown of the electric field as well as short-circuits.

The advantageous embodiment as claimed in claim 5 additionally brings about that the electric field in the area of the optical layer is higher.

By means of the advantageously selected materials as claimed in claims 6 through 9, varistor layers can be produced which do not require a sintering step as the high sintering temperatures in excess of 800° C. are not compatible with the manufacturing conditions for display devices.

The invention further relates to a method of manufacturing a display device comprising a first electrode and a second electrode, and an optical layer arranged between the electrodes, which optical layer emits light under the influence of an electric field applied between said electrodes, and comprising a varistor layer arranged between an electrode and the optical layer, said varistor layer being provided by means of blade coating or screen printing.

These and other aspects of the invention are apparent from and will be elucidated with reference to two Figures and two exemplary embodiments.

In the drawings:

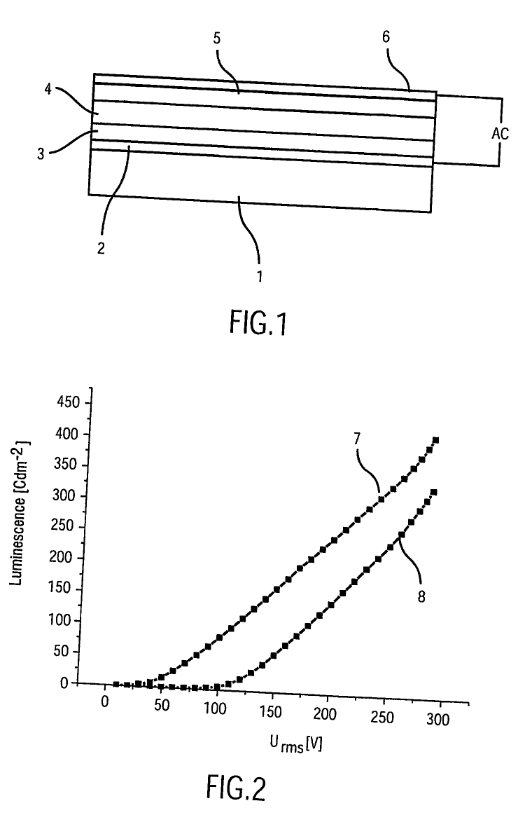

FIG. 1 is a cross-sectional view of the structure of a display device in accordance with the invention, and

FIG. 2 shows the luminance-voltage curve of a customary display device in comparison with that of a display device in accordance with the invention having a varistor layer.

As shown in FIG. 1, a preferred embodiment of the display device in accordance with the invention comprises a transparent substrate 1 containing, for example, glass or a synthetic resin. On the transparent substrate 1 there is provided a first electrode 2 of parallel-arranged, conductive stripes. The conductive stripes preferably contain a transparent, conductive material such as ITO (indium-doped tin oxide). On the first electrode 2 there is situated an optical layer 3. Said optical layer 3 contains one or more materials emitting light under the influence of an electric field. On the optical layer 3 there is provided a dielectric layer 4 of a dielectric material having preferably a dielectric constant ε>20. Said dielectric layer 4 comprises, for example, BaTiO₃. A varistor layer 5 borders on the dielectric layer 4, and said varistor layer 5 is provided with a second electrode 6 of parallel-arranged, conductive stripes, said conductive stripes of the second electrode 6 being arranged orthogonally with respect to the conductive stripes of the first electrode 2. Preferably, the second electrode 6 contains a metal, such as silver, as the conductive material. The conductive stripes of the two electrodes 2, 6 are each provided with electric connections and connected to a voltage source.

Preferably the display device is provided with a protective envelope of a synthetic resin, such as polymethyl methacrylate, to protect the display device, in particular against moisture.

The varistor layer 5 preferably is a closed layer that extends parallel to the optical layer 4, throughout the surface over which also the optical layer 4 extends. Alternatively, the varistor layer 5 may be structured and exhibit a pixel-shaped structure. In this embodiment, the varistor layer 5 is provided only in the areas of the pixels, i.e. the areas where conductive stripes of the two electrodes 2, 6 overlap one another.

The varistor layer 5 preferably comprises substantially ZnO doped with at least one material selected from the group consisting of Bi₂O₃, Co₂O₃, MnO₂, Sb₂O₃, Al₂O₃ and B₂O₃, or it comprises substantially SrTiO₃ doped with at least one material selected from the group consisting of La₂O₃, Nb₂O₅ and WO₃, or it comprises substantially YTiO₃ doped with at least one material selected from the group consisting of La₂O₃, Nb₂O₅ and WO₃, or it comprises a polymeric matrix in which doped ZnO particles or doped SrTiO₃ particles are distributed.

To manufacture a varistor layer 5, first the material of the varistor layer 5 is prepared in powdery form. Subsequently, the varistor layer 5 is produced by means of blade coating or screen printing. Particularly if the varistor layer 5 is structured, the screen printing method is very suitable.

In the blade coating process, a certain quantity of the powdery material of the varistor layer 5 is mixed with the same quantity of a binder, for example Baysilone from the firm of Bayer. The mixture obtained is applied at a blade distance of preferably 30 to 300 μm onto the optical layer 3 or the dielectric layer 4, dependent upon the structure of the display device, and subsequently dried. The thickness of the varistor layer 5 after drying ranges between 10 and 60 μm.

To prepare a screen printing paste, 60 to 70% by weight of the powdery material of the varistor layer 5 is stirred in a suitable thixotropic matrix. The paste obtained is printed onto the optical layer 3 or the dielectric layer 4 and subsequently dried.

The manufacture of the other layers and structured electrodes takes place in accordance with customary methods.

In FIG. 2, the luminance-voltage curves of a customary display device 7 and a display device 8 in accordance with the invention with a closed varistor layer of ZnO doped with Bi₂O₃, Co₃O₄ and Al₂O₃ are shown.

In comparison with a customary display device, a display device in accordance with the invention has a clearly higher light emission threshold. Also the slope of the luminance-voltage curve, particularly at higher voltages, is steeper than that of a customary display device. Said two factors cause the contrast of a display device in accordance with the invention to be better.

The optical layer 3 contains electroluminescent materials and, very preferably, ZnS:Cu-based electroluminescent materials. A blue light emission is obtained by co-activation with Cl, i.e. by ZnS:Cu,Cl, a green light emission can be obtained by co-activation with Al, i.e. by ZnS:Cu,Al, and a red light emission is obtained by co-activation with Al and Mn, i.e. by ZnS:Cu,Al,Mn. The light emission can be shifted towards longer wavelengths by substituting part of the Zn in ZnS:Cu with, for example, Cd, as a result of which the bandgap of the crystal is reduced. Alternatively, the emission color of a sub-pixel can be influenced by admixing phosphors that can be excited by blue light (re-emitters). In addition, the emission color of a sub-pixel can be varied by means of color filters as well as by means of color filters and a black matrix on the substrate 1 or on the first electrode 2.

### EXAMPLE 1

To prepare powdery Bi₂O₃, Co₃O₄ and Al₂O₃-doped ZnO, first ZnO with 2.5 wt. % AM(OH)₃ was ground with 1 kg of 2 mm thick yttrium-stabilized zirconium oxide balls in isopropanol for 16 hours. After removal of the grinding balls the material obtained was dried by means of an IR lamp. The dried powder was subsequently calcined at 1000° C. in air for 6 hours. The calcined coarse-grain powder was subsequently ground again in isopropanol for 6 hours using 20 mm thick yttrium-stabilized zirconium oxide balls. After removal of the grinding balls the material obtained was dried by means of an IR lamp. Subsequently, the Al₂O₃-doped ZnO obtained and 5 wt. % Bi₂O₃ and 1 wt. % Co₃O₄ was ground for 3 hours in isopropanol using 1 kg of 2 mm thick yttrium-stabilized zirconium oxide balls. After removal of the grinding balls, the material obtained was dried by means of an IR lamp. The dried powder was subsequently calcined at 900° C. in air for 0.5 hours. The calcined powder was then ground again in cyclohexane using a ball mill. Subsequently the powder was dried and passed through a 0.125 mm sieve.

### EXAMPLE 2

A transparent substrate 1 of glass was provided with a layer of ITO which was structured by means of photolithography and etching using bromium acid to a first electrode 2 of parallel, conductive stripes. Subsequently the optical layer 3 was provided on the first electrode 2 by means of screen printing. The optical layer 3 contained three different electroluminescent materials and exhibited a pixel-shaped structure with sub-pixels emitting red light, blue light or green light. In the red-emitting sub-pixels of the optical layer 3, ZnS:Cu,Al,Mn was used. In the green-emitting sub-pixels of the optical layer 3, ZnS:Cu,Al was used. In the blue-emitting sub-pixels of the optical layer 3, ZnS:Cu,Cl was used. The thickness of the optical layer 3 was 25 μm. A 28 μm thick dielectric layer 4 containing BaTiO₃ was provided on the optical layer 3. A 20 μm thick varistor layer of ZnO doped with Bi₂O₃, Co₂O₄ and Al₂O₃ was provided on the dielectric layer 4 by means of blade coating. Subsequently, a second electrode 6 was printed on the varistor layer 5. Said second electrode 6 contained parallel-arranged stripes of silver which were arranged orthogonally with respect to the conductive stripes of the first electrode 2.

The individual, conductive stripes of the electrodes 2, 6 were electrically contacted and connected to a voltage source. The display device was integrally provided with a protective envelope of polymethacrylate.

The display device exhibited a 300% higher contrast in comparison with a customary display device without varistor layer.

1. A display device comprising a first electrode and a second electrode, and an optical layer arranged between the electrodes, which optical layer emits light under the influence of an electric field applied between said electrodes, and comprising a varistor layer arranged between an electrode and the optical layer.

2. A display device as claimed in claim 1, characterized in that the varistor layer is structured and situated in the areas where the first electrode and the second electrode overlap one another.

3. A display device as claimed in claim 1, characterized in that the varistor layer is arranged parallel to the optical layer, and the surface over which the varistor layer extends corresponds to the surface over which the optical layer extends.

4. A display device as claimed in claim 1, characterized in that a dielectric layer is situated between the optical layer and the varistor layer.

5. A display device as claimed in claim 4, characterized in that the dielectric layer comprises a dielectric material having a dielectric constant ε>20.

6. A display device as claimed in claim 1, characterized in that the varistor layer substantially comprises ZnO doped with at least one material selected from the group consisting of Bi₂O₃, Co₂O₃, MnO₂, Sb₂O₃, Al₂O₃ and B₂O₃.

7. A display device as claimed in claim 1, characterized in that the varistor layer substantially comprises SrTiO₃ doped with at least one material selected from the group consisting of La₂O₃, Nb₂O₅ and WO₃.

8. A display device as claimed in claim 1, characterized in that the varistor layer substantially comprises YTiO₃ doped with at least one material selected from the group consisting of La₂O₃, Nb₂O₅ and WO₃.

9. A display device as claimed in claim 1, characterized in that the varistor layer comprises a polymeric matrix in which doped ZnO particles or doped SrTiO₃ particles or doped YTiO₃ particles are distributed.

10. A method of manufacturing a display device comprising a first electrode and a second electrode, and an optical layer arranged between the electrodes, which optical layer emits light under the influence of an electric field applied between said electrodes, and comprising a varistor layer arranged between an electrode and the optical layer, characterized in that the varistor layer is applied by means of blade coating or screen printing.
